(19) United States
(12) Patent Application Publication
(10) Pub. No.: US 2020/0082435 A1
(43) Pub. Date: Mar. 12, 2020

(54) WIN DRAW SYSTEM AND METHOD

(71) Applicant: Karleigh Jackson, Barrhead AB (CA)

(72) Inventor: Karleigh Jackson, Barrhead AB (CA)

(21) Appl. No.: 16/132,010

(22) Filed: Sep. 14, 2018

(30) Foreign Application Priority Data
Sep. 6, 2018 (CA) 3,016,666

(51) Int. Cl. G06Q 30/02; G06F 21/62; G06F 17/30; G06Q 20/36

(52) U.S. Cl. CPC G06Q 30/0251; G06Q 20/367; G06F 17/30241; G06F 21/6218

(57) ABSTRACT

A win draw system including: a server including a processor, and a memory in communication with the processor, the memory having a database comprising at least data related to wildlife animal populations and to human-populations, and a device (such as a smartphone or the like) capable of accessing GPS and including a user-interface configured to enable communication with the server via a software application. A method for promoting hunting activities is also available for use.

### BACKGROUND OF THE INVENTION

This application claims benefit under 35 USC 119 to Canada National Application No. 3,016,666 filed on Sep. 6, 2018 the disclosure of which is incorporated herein by reference in its entirety. The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of data processing: database and file management or data structure of existing art and more specifically relates to a win draw system and method.

### RELATED ART

Many individuals in modern society enjoy viewing wildlife. Wildlife help to keep our environment balanced and clean when in proper proportion. Hunting may be used as a means to control populations of wildlife at a healthy level to avoid sickness, starvation and other problems caused by over-population. Some people do not realize that hunting is used as a form of population management as well as a way to feed the hunter and his/her family. A stigma is often attached to hunting which is negative. It is desirable that conservation of wildlife increase by education in an efficient and effective manner. A suitable solution is desired.

U.S. Pub. No. 2012/0011076 to Jonathan A. Crissy relates to a smartphone-implemented method of obtaining a fishing or hunting license. The described smartphone-implemented method of obtaining a fishing or hunting license includes a smartphone-implemented method of obtaining fishing or hunting license, comprising the steps of: a) Establishing online communication between a smartphone and a fishing and hunting license server; b) downloading a fishing and hunting license application to the smartphone; c) selecting the state and county in which the fishing or hunting activity will be performed; d) selecting the animal right the fisherman or hunter is planning to catch or hunt; e) reading and accepting the animal information, including slot, bag and harvest season limits and regulations; f) selecting the type of license needed for performing the fishing or hunting activity; g) inserting the fisherman's or hunter's personal information; h) paying the license fees; i) validating the user data and the payment information data; j) issuing and sending the license certificate from the fishing and hunting license server; k) storing the license certificate in the smartphone memory. By using the above mentioned online application, the user is able to obtain a fishing or hunting license without the need of going to a specialized store.

### SUMMARY OF THE INVENTION

In view of the foregoing disadvantages inherent in the known: database and file management or data structure art, the present disclosure provides a novel win draw system and method. The general purpose of the present disclosure, which will be described subsequently in greater detail, is to provide a win draw system and method.

A win draw system in a preferred embodiment is disclosed herein comprising: a server including a processor, and a memory in communication with the processor, the memory having a database comprising at least data related to wildlife animal populations and to human-populations, and a device (such as a smartphone or the like) capable of accessing GPS and including a user-interface configured to enable communication with the server via a software application. The human-populations referred to herein comprises at least conservation officers and hunters; wherein the conservation officers are able to track hunting of the hunters via the GPS and cross-referencing to the database and the conservation officers are also able to communicate privately with respect to referenced-data via the software application (the conservation officers need to provide identification verification to access conservation-officer-authorized-data via the software application).

The human-populations may further comprise at least landowners; the landowners able to advertise land available for hunting to the hunters. The landowners are able to report a poacher, a problem animal, at least one suspicious activity via the software application. The human-populations may further comprise outfitters; the outfitters being able to advertise hunting-services available for hunting to the hunters. The human-populations may further comprise sponsors; the sponsors are able to advertise hunting-products available for hunting to the hunters. The hunters have access to E-tags and E-licenses and a list of valid-tags and valid-licenses such that the hunter can purchase the E-tags and the E-licenses. The E-tags can be offloaded to wallet and information related to harvested-wildlife is submittable (some is voluntary some is involuntary). Further, the human-populations have access to newsfeed and forums and well as other valuable information. The win draw system is a paid subscription such that the win draw system is monetizable and safe-hunting as conservation is promoted in a favorable light.

A method of use for the win draw system is also disclosed herein; the method comprising the steps of: providing access to the win draw system to conservation officers, hunters, landowners, outfitters, sponsors via a software application; providing the hunters with access to hunting-information and the capability to purchase E-tags and E-licenses; monetizing the win draw system via use by the landowners, the outfitters, and the sponsors in relation to the hunters via purchases through the software application, (offering at least) advertising, promotions and prizes, referrals generated, and subscriptions purchased; incentivizing conservation efforts, and promoting hunting-education (placing hunting in a favorable light). Other steps may include: mapping out hunting-areas, and tracking the hunters; providing hunting guides, trapping guides, and fishing guides, and providing newsfeed and forums.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a win draw system and method, constructed and operative according to the teachings of the present disclosure.

FIG. 1 is a view of the win draw system and method during an ‘in-use’ condition, according to an embodiment of the disclosure.

FIG. 2 is a view of the win draw system and method of FIG. 1, according to an embodiment of the present disclosure.

FIG. 3 is another view of the win draw system and method of FIG. 1, according to an embodiment of the present disclosure.

FIG. 4 is a view of the win draw system and method of FIG. 1, according to an embodiment of the present disclosure.

FIG. 5 is a flow diagram illustrating a method of use for the win draw system and method, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to: database and file management or data structure and more particularly to a win draw system and method as used to improve the conservation of wildlife and human awareness as to the positive aspects of hunting. As described herein, a “WIN” or Wildlife Identification Number is an identity number required to request a hunting license (or equivalent) from the proper authorities. It is to be understood that different location and regimes may use different terminology and acronyms to refer to this identity number, however, the term “WIN” or “win” is used herein for convenience to describe all such equivalent identity numbers.

Generally speaking, the present system allows for better accessing and indexing which: will digitize hunting draws, renewals and tags; reduce paper; eliminate lost tags (tags are electronic); decrease poaching, and increase conservation; allows for advertising and guide related industry revenue; better access to firearm training and hunter training; allows for sponsorships; an individual can pre-book for draws and receive draw and payment reminders; allows for better tracking of hunters, areas and areas; map feature for hunters; and better search and rescue as hunters can be easily tracked.

Referring now to access: 1.) Separate access for each of the following: A.) Conservation Officer via verified badge ID and password or fingerprint verification. Conservation officers will have access to the following: GPS location of all users and ability to lookup via location indicator; WIN ID database to search hunter/outfitter and relevant data required by officer; cross reference to land owner permission; data analysis of app content pertaining to conservation; portions of the app pertaining to safety and survival; officers able to send relevant data to one another via app; ability to search a suspicious persons full app record with issued warrant (Police); receives emails sent from user to closest available agent in regards to suspicious activity as per GPS location of user and officer; and access to this database for annual fee. B.) Outfitter via verified outfitter ID and password or fingerprint verification Outfitters will have access to the following: License, Tag and draw purchases via outfitter license and all other Hunter (User) features; able to set up account similar to hunter/user but under company name and ID with ability to promote their business for a fee, also additional app features for a fee or monthly/yearly subscription; advertise available hunts; sell available hunts; answer inquiries about hunts; update hunts issued, hunts available, spots available; notification and confirmation of hunt sent to buyer and seller; generate report regarding online sales; reminder of upcoming hunt for buyer and seller; ability to send information package and necessary information for hunt via in app inbox to buyer. C.) Hunter (User) via WIN ID and password or fingerprint verification. Hunters (Users) will have access to the following: Only Hunter (user) features. (Additional features for a monthly/yearly subscription) D.) Landowner (NO WIN), ability to select option Landowner and automatically sent to section where data pertaining to advertising land available to hunt is located; data entry of location, contact via email or phone, name, additional notes, species; report a poacher; report a problem animal; report suspicious activity (Police); login is for persons without WIN and has very limited features; WIN card sign up option for people without WIN card (doc sign for signature verification).

Referring now to tags 1.) Access to E-tags; list of valid tags 2.) Ability to buy E-tags; purchase tags and instantly add them to your valid tag list (% for each tag purchased); 3.) Ability to offload E-tags to wallet; option to access tag offline for reference 4.) Ability to submit and add data to E-tag; after a harvest occurs entry of data must be added and submitted this must include: photo ID of harvested animal specifying gender, entry, wound location, gps verified location, and weapon used. (Additional mandatory data for Outfitter, appropriate hunter documentation, etc.); optional data of weight, animal score, notes and any other information useful for conservation; incentive to send harvested animal sample to appropriate service to aid in disease control of animal population; tags must all be submitted by the end of the hunting season either filled with harvest information or submitted as unfilled. If there are expired tags on the list that have not been submitted the user will be unable to purchase new tags; notification added when tags are partially filled to complete tag; notification added to submit tags (used/unused); notification of tags available per set WMU. 5.) Tag data is archived for Hunter/User/Outfitter retrieval as reference. 6.) Tag data is recorded for conservation sector usage 7.) Easy search via WMU, WEAPON, ANIMAL for tag purchase 8.) Confirmation of payments sent to inbox in app as well as optional text message.

Referring now to licenses: 1.) Access to E-license; List of valid licenses 2.) Ability to purchase E-licenses; purchase licenses and instantly adds to your valid license list; notification for licenses available as per set WMU 3.) Ability to offload E-license to wallet; option to access licenses offline 4.) Easy auto renewal option for licenses; option to automatically renew license before expiration occurs (subscription required) 5.) Visible expiration date of licenses; notification for expiration 1 week prior via in app inbox and optional text message 6.) Ability to easily search for appropriate licenses required by location, hunting, fishing, trapping, special 7.) Confirmation of payments sent to inbox in app as well as optional text message 8.) Ability to access boating license through app; ability to offload to wallet; ability to take boating test via link C.) Draws 1.) Ability to submit draw entry form (Year 1) draw form available for edit until said date; notification for draw entry close date; notification of last chance to edit draw form; notification of draw form submission; notification of payment decline; notification of default payment decline; notification of confirmation of payment; notification of draw date result; notification of draw results available. 2.) Ability to find necessary draws easily through search filter. WMU, weapon, animal. 3.) Ability to submit Year 1 draw form regularly (open/close dates) only in unpaid version; 4.) Ability to add 2 additional draw entry forms (Year 2, Year 3) subscription required; fill in additional forms to save and edit till said date, when date is passed draw form is automatically sent for said year. 5.) ability to auto submit saved draw forms (Year 1, Year 2, Year 3) subscription required; if changes to future year draw forms are made, the draw forms are changed and any persons effected will receive notification via in app inbox and optional text message so they can make necessary changes. To ensure draws are not missed a default payment can be added to account payment information section. Notification options to avoid missing draw deadline D.) Inbox 1.) Received messages can be set to show up as notification on phone as well as optional text message 2.) Inbox receives information pertinent to users registered WMU and bought tag/license WMU or Province/Country as per preferences. 3.) Inbox receives updates to hunting and fishing regulation handbook 4.) Inbox receives dangerous animal advisory for specified area 5.) Inbox receives conformation of payments 6.) Inbox receives draw results 7.) Inbox receives any other information as sent by conservation officers or sectors 8.) Inbox can receive emails and send emails to anyone using the app eg. Landowners, Conservation, Hunters/User, Outfitter 9.) Inbox can receive emails from outfitters 10.) Inbox has easy to use feature to email relevant information to nearest wildlife official.

Referring now to advertising 1.) Landowners with or without WIN ID can advertise land available for hunting; separate entry available on log in screen to access landowner only features; data recorded/collected and available for cross reference if conflict or accusation occurs (conservation access only) 2.) Outfitters/Guides must have appropriate licensing to access advertising options; ability to add and change advertising information pertaining to their company; ability to keep better track of hunt availability; ability to keep better record of past information for company; ability to sell and create more awareness of service; ability to receive online payments via PAYPAL, MASTERCARD, VISA, APPLE; ability to track revenue 3.) Sponsors/Companies hunting, fishing, trapping related companies, taxidermy, butcher shops, outfitters, RV, ATV, Boat sales and rentals, camping supplies stores, specialty restaurants, apparel, ammunition and weapons, etc. Ability is provided to contact necessary persons and for a fee can advertise on app; ability to gain revenue due to increased advertising; ability to promote services and sales; ability to advertise/organize contests and prizes; ability to make purchases/bookings for events, seminars or training via app for % of cost; ability to provide information on resources or news relating to app revenues; % of purchases through app; adverting (large and small companies; promotions and prizes; referral system for recruiting users (discount or gift); conservation generated data ($); outfitter generated data ($); and subscription or cost of app Newsfeed/Forum.

Also provided is: 1.) Access via software application to users to answer and ask questions 2.) Access to users to view recorded trophy animals as per fish and wildlife associations and WMU area (trophy feature updated to include top hunters on a yearly basis with prize recognition per state and province) 3.) Access for users to upload links for wild game recipes; access to share and save recipes; advertising for butcher shop services apply for booking; advertising for cooking, baking, prepping home features 1.) Access to regulation hunting and fishing guide; easy to lookup search bar by WMU, Province/State/Country/Species/Weapon; key word search feature; index; hunting, fishing, trapping glossary 2.) Access to information/services; bear and cougar awareness and safety; endangered/protected species; hunter/angler/trapper safety; weapon safety; problematic and/or dangerous animal relocation information and access to report to nearby official via instant message option; access to online report a poacher click and call number; access to report an invasive species or diseases animal; access to report an injured animal to nearby official; in reach or like service for emergency response in locations without cell service via GPS satellite.

Referring now to safety; the present invention provides the ability to receive help without cell service; ability to see other hunters via GPS indicator to know to stay out of an area; ability to see residence via GPS to know which direction is safe to shoot; ability to receive information pertaining to safety; easily access information to educate about safety; reduce hunting/trapping/angling/etc. related incidents or fatalities due to education, awareness, resources.

Referring now to Settings & Notifications 1.) Change settings to set one or multiple WMU Access to information only for set WMU'S relevant to hunter/outfitter/conservation 2.) Contact information/Account WIN verified name; GPS verified location; access to change contact information only (Name changes must be verified by necessary official and changed through their access only) 3.) GPS location must be active in order for this app to work (direct to enable GPS) 4.) Payment and default payment to allow for less problem of expired or missed licenses/deadlines/subscriptions. Payment methods include: PayPal, VISA, MasterCard, Apple 5.) Subscription renewal access and options 6.) Auto update app 7.) All indicated notifications/reminders through document 8.) Setting to set preferences of what you see in app as per advertisements, news, etc. 9.) Setting to allow notification on phone and/or text message Additional Features (Add Ons/Subscription Only) 1.) Range Finder Feature; ability to find range of target using camera; record groupings on weapons; record weapon information regarding sighting in, cleaning, preferred ammo, additional notes and maintenance; ability to access gun information of user (Conservation, Officer) 2.) Rate Your Rack; feature to take picture of animal and have it scaled via Boone and Crockett to give an approximate scoring; information on how scoring works; ability to save picture and upload to trophy room 3.) Show us your racks; upload pictures and comment, like, share; trophy room to view only images uploaded per WMU/Province/Country of all users; add friends and have ability to view individuals trophy rooms, send messages view shared information. Access hunting party ability to invite friends to private chat and GPS location of hunters while in chat. 4.) Map; map of select province/state showing all WMU'S, Lakes, Rivers, Etc.; zoom allows GPS indicator of hunters in area; zoom allows GPS location; zoom allows home location; click on lakes or rivers to see information regarding fishing information regarding species keep limit, stock reports 5.) Flora/Fauna scavenger hunt; feature to encourage conservation and outdoor activity; take images of animals and plants and store them in “book” try to collect all species and gain points; endangered/protected animals and plants are worth additional points and can be documented multiple times and are registered by GPS location to help with conservation; prizes awarded on a determined basis 6.) Geocaching (Treasure Hunt) clues generated by app and prize hidden that users can seek out (cash prize per country yearly).

Referring now to environmental conservation; incentive to participate in conservation efforts; easily access and provide information to educate about conservation; reduce stigma of hunting; increase sales; reduce poaching; generate more accurate and often reports on conservation; conserving waste (paperless); generating more revenue for conservation due to auto renewal and easier access to sales; educates and creates awareness about respect for animal and plant life.

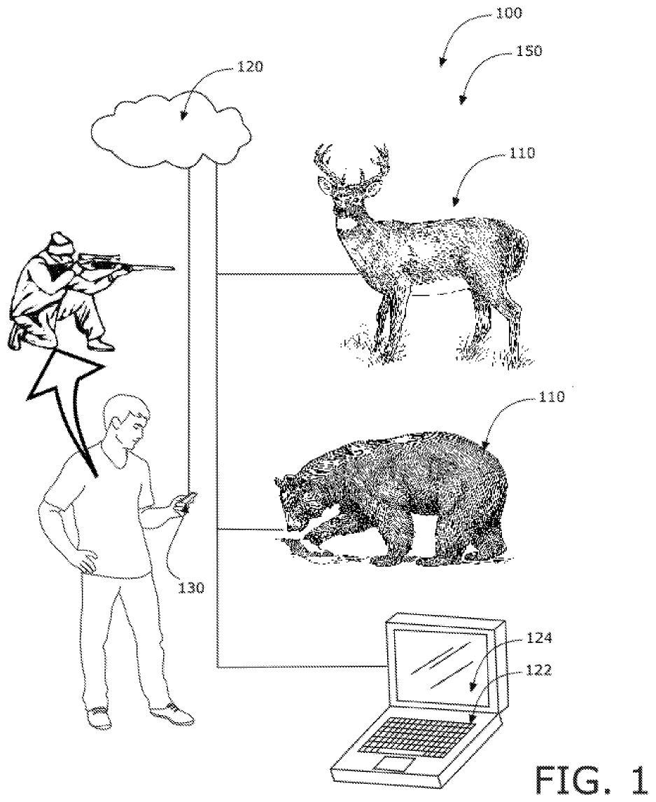

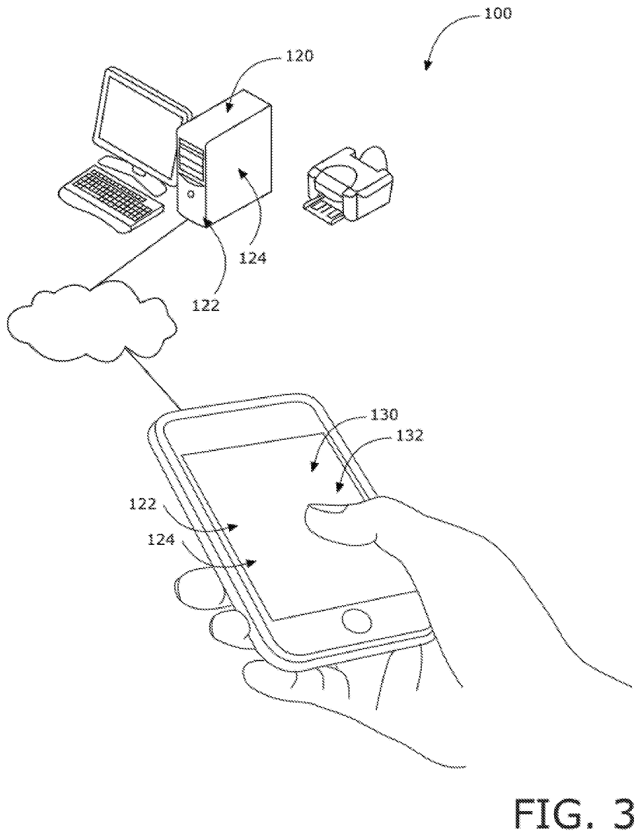

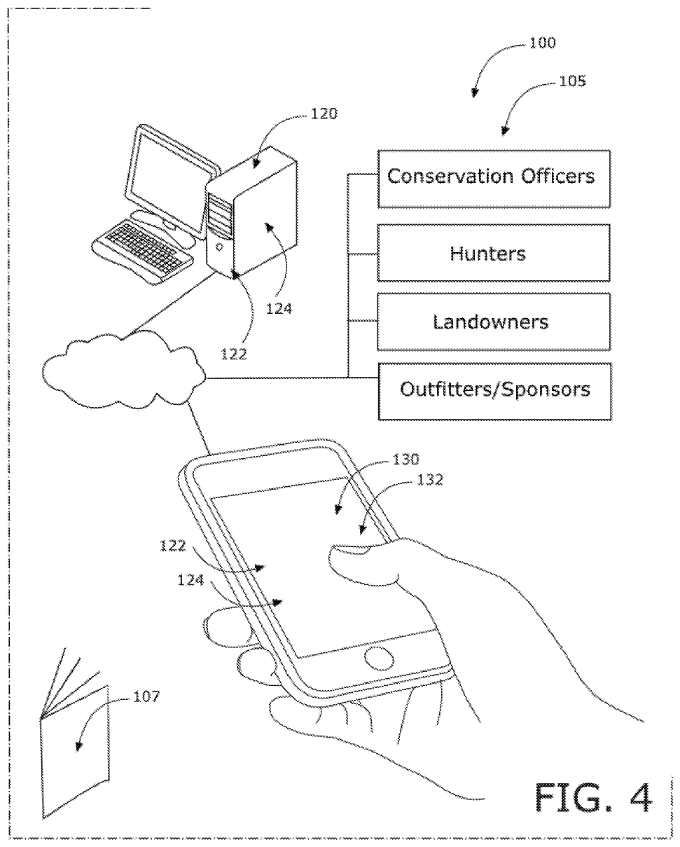

Referring now more specifically to the drawings by numerals of reference, there is shown in FIGS. 1-4, various views of a win draw system 100.

FIG. 1 shows a win draw system 100 during an ‘in-use’ condition 150, according to an embodiment of the present disclosure. Here, the win draw system 100 may be beneficial for use by a user to promote safe hunting and wildlife 110 conservation. As illustrated, the win draw system 100 may include a server 120 including: a processor 122, and a memory 124 in communication with the processor 122; the memory 124 having a database comprising at least data related to wildlife 110 animal populations and to human-populations, and a device capable of accessing GPS and including a user-interface configured to enable communication with the server 120 via a software application 132.

According to one embodiment, the win draw system 100 may be arranged as a kit. In particular, the win draw system 100 may further include a set of instructions. The instructions may detail functional relationships in relation to the structure of the win draw system 100 such that the win draw system 100 can be used, maintained, or the like, in a preferred manner.

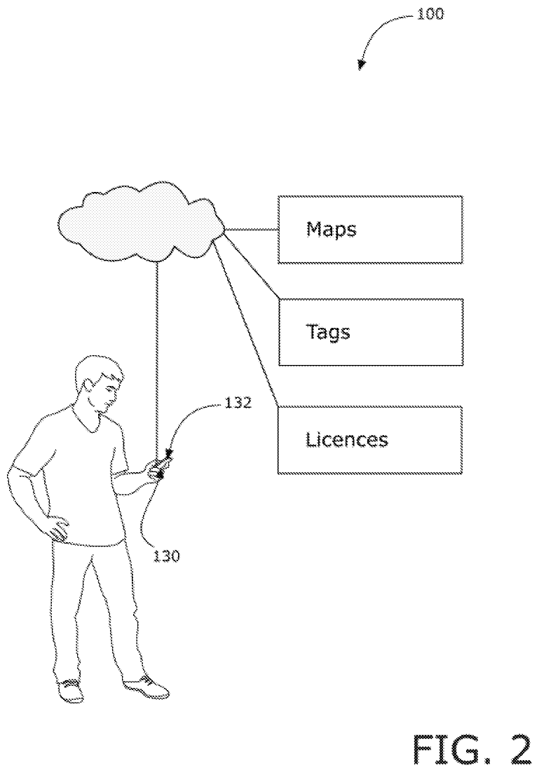

Referring now to FIGS. 2-4 showing various views of the win draw system 100 of FIG. 1, according to an embodiment of the present disclosure.

The human-populations comprise at least conservation officers and hunters. The conservation officers are able to track hunting of (by) the hunters via the GPS and cross-referencing to the database. Using this information the conservation officers are able to communicate privately with each other with respect to referenced-data via the software application 132. The conservation officers need to provide identification verification to access conservation-officer-authorized-data via the software application 132 to keep the system 100 secure in use. The human-populations of the win draw system may also comprise at least landowners and hunters; wherein the landowners are able to advertise land available for hunting to the hunters. The landowners are able to report a poacher via the software application 132. The landowners are also able to report a problem animal via the software application 132. The landowners are further able to report at least one suspicious activity to police via the software application 132. The landowners with no-win-access have limited access. The win draw system is a paid subscription for most involved parties.

The human-populations may further comprise outfitters and hunters; wherein the outfitters are able to advertise hunting-services available for hunting to the hunters. The human-populations may also comprise sponsors and hunters; wherein the outfitters are able to advertise hunting-products available for hunting to the hunters. At least a portion of the services are able to be monetized as described subsequently herein. The outfitters are able to access license-information and access tag-information. The hunting-products are selected from the group consisting of available-hunts, available-hunting-areas, and hunting-product-offerings as available on the win draw system 100. Those with ordinary skill in the art will now appreciate that upon reading this specification and by their understanding the art of online access via an application software, communication, authorization means, monetizing as described herein, methods of providing such accessible services will be understood by those knowledgeable in such art.

The hunters have access to E-tags and E-licenses and a list of valid-tags and valid-licenses such that the hunter(s) can purchase the E-tags and the E-licenses online. The E-tags can be offloaded to wallet and information related to harvested-wildlife is submittable.

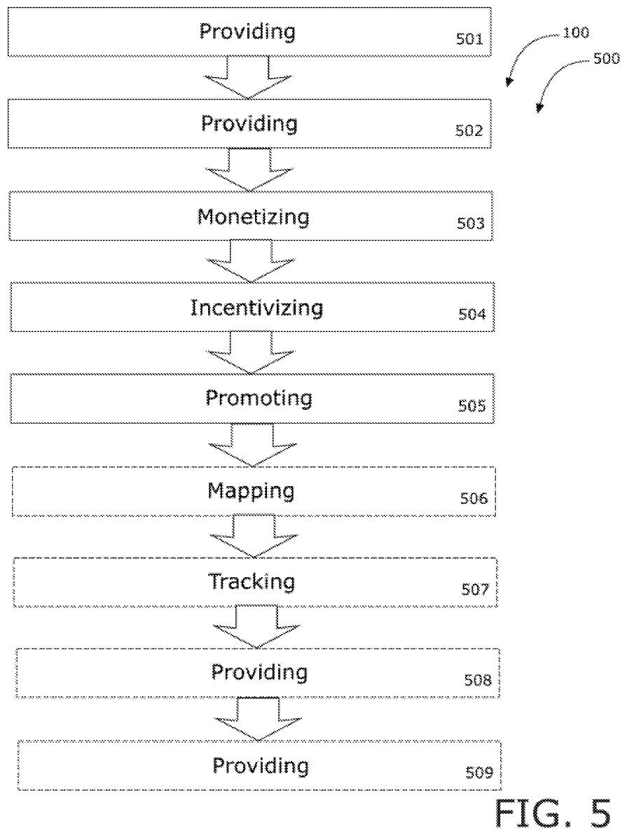

Referring now to FIG. 5 showing a flow diagram illustrating a method of use 500 for win draw system 100, according to an embodiment of the present disclosure. In particular, the method of use 500 may include one or more components or features of the win draw system 100 as described above. As illustrated, the method of use 500 may include the steps of: step one 501, providing access to the win draw system to conservation officers, hunters, landowners, outfitters, sponsors via a software application; step two 502, providing the hunters with access to hunting-information and the capability to purchase E-tags and E-licenses; step three 503, monetizing the win draw system via use by the landowners, the outfitters, and the sponsors in relation to the hunters via purchases through the software application, (offering at least) advertising, promotions and prizes, referrals generated, and subscriptions purchased; step four 504 incentivizing conservation efforts; step five 505 promoting hunting-education and placing hunting in a favorable light; step six 506 mapping out hunting-areas; step seven 507 tracking the hunters; step eight 508 providing hunting guides, trapping guides, and fishing guides; step nine 509 providing newsfeed and forums.

It should be noted that steps 506-509 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for promoting conservation, hunting, safety and the like are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A win draw system comprising:
a server including:
a processor; and
a memory in communication with the processor, the memory having:
a database comprising at least data related to wildlife animal populations and to human-populations; and
a device capable of accessing GPS and including:
a user-interface configured to enable communication with the server via a software application.

2. The win draw system of claim 1, wherein said human-populations comprises at least conservation officers and hunters and wherein said conservation officers are able to track hunting of said hunters via said GPS and cross-referencing to said database and wherein said conservation officers are able to communicate privately with respect to referenced-data via said software application.

3. The win draw system of claim 2, wherein said conservation officers need to provide identification verification to access conservation-officer-authorized-data via said software application.

4. The win draw system of claim 1, wherein said human-populations comprises at least landowners and hunters and wherein said landowners are able to advertise land available for hunting to said hunters.

5. The win draw system of claim 1, wherein said human-populations comprises outfitters and hunters and wherein said outfitters are able to advertise hunting-services available for hunting to said hunters.

6. The win draw system of claim 1, wherein said human-populations comprises sponsors and hunters and wherein said outfitters are able to advertise hunting-products available for hunting to said hunters.

7. The win draw system of claim 6, wherein said outfitters are able to access license-information.

8. The win draw system of claim 6, wherein said outfitters are able to access tag-information.

9. The win draw system of claim 6, wherein the hunting-products are selected from the group consisting of available-hunts; available-hunting-areas; and hunting-product-offerings.

10. The win draw system of claim 4, wherein the landowners are able to report a poacher via said software application.

11. The win draw system of claim 4, wherein the landowners are able to report a problem animal via said software application.

12. The win draw system of claim 4, wherein the landowners are able to report at least one suspicious activity to police via said software application.

13. The win draw system of claim 12, wherein the landowners with no-win-access have limited access.

14. The win draw system of claim 2, wherein the hunters have access to E-tags and E-licenses and a list of valid-tags and valid-licenses such that said hunter can purchase said E-tags and said E-licenses.

15. The win draw system of claim 14, wherein the E-tags can be offloaded to wallet and information related to harvested-wildlife is submittable.

16. The win draw system of claim 1, wherein the win draw system is a paid subscription.

17. A win draw system comprising:
a server including:
a processor; and
a memory in communication with the processor, the memory having:
a database comprising at least data related to wildlife animal populations and to human-populations; and
a device capable of accessing GPS and including:
a user-interface configured to enable communication with the server via a software application;
wherein said human-populations comprises at least conservation officers and hunters and wherein said conservation officers are able to track hunting of said hunters via said GPS and cross-referencing to said database and wherein said conservation officers are able to communicate privately with respect to referenced-data via said software application;
wherein said conservation officers need to provide identification verification to access conservation-officer-authorized-data via said software application;
wherein said human-populations further comprises at least landowners, said landowners able to advertise land available for hunting to said hunters;
wherein said human-populations further comprises outfitters, said outfitters being able to advertise hunting-services available for hunting to said hunters;
wherein said human-populations further comprises sponsors, said sponsors are able to advertise hunting-products available for hunting to said hunters;
wherein the landowners are able to report a poacher, a problem animal, at least one suspicious activity via said software application;
wherein the hunters have access to E-tags and E-licenses and a list of valid-tags and valid-licenses such that said hunter can purchase said E-tags and said E-licenses;
wherein the E-tags can be offloaded to wallet and information related to harvested-wildlife is submittable;
wherein said human-populations have access to newsfeed and forums; and
wherein the win draw system is a paid subscription such that said win draw system is monetizable and safe-hunting as conservation is promoted in a favorable light.

18. A method of use for the win draw system, the method comprising the steps of:
providing access to the win draw system to conservation officers, hunters, landowners, outfitters, sponsors via a software application;
providing said hunters with access to hunting-information and capability to purchase E-tags and E-licenses;
monetizing the win draw system via use by said landowners, said outfitters, and said sponsors in relation to said hunters via purchases through said software application, advertising, promotions and prizes, referrals generated, and subscriptions purchased;
incentivizing conservation efforts; and
promoting hunting-education.

19. The method of claim 18, further comprising the steps of:
mapping out hunting-areas; and
tracking said hunters.

20. The method of claim 19, further comprising the steps of:
providing hunting guides, trapping guides, and fishing guides; and
providing newsfeed and forums.
